(19) United States
(12) Patent Application Publication
(10) Pub. No.: US 2019/0299231 A1
(43) Pub. Date: Oct. 3, 2019

(54) APPLICATION DEVICE AND METHOD FOR APPLYIN A COATING MEDIUM

(71) Applicant: Dürr Systems AG, Bietigheim-Bissingen (DE)

(72) Inventors: Hans-Georg Fritz, Ostfildern (DE); Benjamin Wöhr, Eibensbach (DE); Marcus Kleiner, Besigheim (DE); Moritz Bubek, Ludwigsburg (DE); Timo Beyl, Besigheim (DE); Frank Herre, Oberriexingen (DE); Steffen Sotzny, Oberstenfeld (DE)

(21) Appl. No.: 16/468,701

(22) PCT Filed: Dec. 1, 2017
(86) PCT No.: PCT/EP2017/081123

§ 371 Date: Jun. 12, 2019

(30) Foreign Application Priority Data
Dec. 14, 2016 (DE) 10 2016 014 919.1

(51) Int. Cl. B05B 7/08; B05B 7/06; B05B 12/04; B05B 13/04; B05B 15/55; B41J 2/14

(52) U.S. Cl. CPC B05B 7/0846; B05B 7/061; B41J 2/1433; B05B 13/0452; B05B 15/55; B05B 12/04

(57) ABSTRACT

An application device for the application in series of a paint or other coating compositions to motor vehicle bodies or add-on parts thereof has a nozzle print head which contains a plurality of nozzles arranged, for example, in one or more rows, which apply the coating composition to the surface to be coated as continuous jets or individual drops. The nozzle print head is arranged on a multi-axis coating robot. In contrast to application devices of this type known hitherto, the coating composition consists of at least two components which are to be mixed together, such as, for example, 2K paint, which are fed to the nozzle print head via separate supply lines for jointly supplying the nozzles.

### CROSS-REFERENCE TO RELATED APPLICATIONS

This application is a national stage of, and claims priority to, Patent Cooperation Treaty Application No. PCT/EP2017/081123, filed on Dec. 1, 2017, which application claims priority to German Application No. DE 10 2016 014 919.1, filed on Dec. 14, 2016, which applications are hereby incorporated herein by reference in their entireties.

### BACKGROUND

The disclosure relates to an application device for the application in series of a coating composition to surfaces of workpieces, in particular of motor vehicle bodies and/or add-on parts thereof, having a nozzle applicator, referred to as a nozzle print head hereinbelow, which contains at least one nozzle or preferably a plurality of nozzles arranged side by side, which apply the coating composition to the surface to be coated as continuous jets or individual drops. “Application device” means a device which, in addition to the nozzle print head, which in particular is moved by means of a coating robot, can include further units such as the supply unit containing the coating composition and optionally mixers, colour changers and/or a flushing device. The disclosure relates further to a corresponding application and/or cleaning method.

For the general prior art, reference may first be made, for example, to DE 10 2010 019 612 A1, GB 2 367 771 A, DE 10 2013 002 412 A1, DE 198 52 079 A1, WO 2011/044491 A1, DE 200 17 629 U1, DE 694 29 354 T2 and DE 601 25 369 T2.

So-called nozzle print heads are known inter alia from WO 2010/046064 A1 (for continuous jets of paint) and WO 2011/138048 A1 (for generating drops of paint by applying vibration to the coating composition) and allow motor vehicle bodies to be coated, specifically painted, virtually without overspray, because the jets or drops can be directed with point accuracy at the desired surface regions. Coating without overspray has the considerable advantages described, for example, in the mentioned WO 2010/046064 A1 such as minimal losses of coating material and simplification of the coating booth by dispensing with the measures hitherto required for removing the overspray from a painting booth and/or from a waste air stream.

Nevertheless, such print heads can operate with a surface coating capacity of at least 1 m²/min, 2 m²/min, 3 m²/min, 4 m²/min or even 5 m²/min. The application efficiency of the print head can be more than 80%, 90% or even 99%, and in the coating booth the rate of air descent during operation can be less than 0.3 m/s, 0.2 m/s, 0.1 m/s, 0.07 m/s or even 0.05 m/s.

An important component of the nozzle print head can be a nozzle plate having openings formed in a plate plane which serve as nozzles.

All the above-mentioned features and advantages of the mentioned known nozzle print heads also apply to the disclosure described herein.

Furthermore, there is also known, for example, from U.S. Pat. No. 9,108,424 B2 a nozzle print head having a row of ink-jet nozzles for printing a surface with predetermined patterns, which print head works according to the so-called drop-on-demand principle. This principle is based on the use of electric valves, wherein a magnetic valve needle is guided as the plunger in a coil and is pulled up into the coil by supplying a current. A valve opening is thereby freed so that the fluid in question, in this case the ink, is able to emerge as drops of different sizes depending on the opening time. This principle can also be used in the disclosure described herein but, in contrast to the prior art, not for ink.

The above-mentioned application devices and other nozzle print heads that are already known all have the disadvantage that they are unable to satisfactorily apply multicomponent coating compositions such as, for example, the 2K or 3K paints, adhesives, sealants, adhesion promoters, primers, etc. which are conventional per se in the painting of motor vehicle bodies.

### BRIEF DESCRIPTION OF THE DRAWINGS

FIG. 1 is a cross-sectional view through a painting system according to the disclosure for painting motor vehicle body components having print heads as the application devices,

FIG. 2 is the schematic representation of components ejected from two nozzles according to an example of the disclosure,

FIG. 3 is the schematic representation of the generation of mutually overlapping coating points, and

FIG. 4 shows a nozzle unit to be used in an example of the disclosure.

### DETAILED DESCRIPTION

The application device according to the disclosure first has, in accordance with the prior art, a nozzle applicator or nozzle print head for applying the coating composition to the component to be coated. The term “nozzle print head” used within the context of the disclosure is to be interpreted generally and serves merely to differentiate this nozzle applicator from all atomizers (e.g. rotary atomisers, air atomisers, airless atomisers, etc.) that deliver a spray mist of the coating composition to be applied. In contrast therewith, the nozzle print head generates radially narrowly limited coating agent jets or drops, whereby the jet is generated continuously, that is to say cohesively in its longitudinal direction, while the drops each travel in the same direction and are to be separate from one another in the direction of travel. In principle, it is conceivable that the nozzle print head contains only a single nozzle to which the already mixed coating composition is fed, or only two nozzles, of which one nozzle delivers a first component and the other nozzle delivers a second component. However, preference is given to print heads having a plurality of, for example, one or more parallel rows of nozzles.

The disclosure can moreover be implemented with all types of print heads or other nozzle applicators which differ from conventional atomisers in the manner mentioned above.

In addition, there are provided according to the disclosure at least one or two separate supply lines for components of the coating composition which are to be mixed together, which supply lines in typical examples of the disclosure are provided for jointly supplying all the nozzles of the print head with the same coating composition or components thereof. At least two separate supply lines lead to or into the nozzle print head if the components are to be mixed therein or not until they have left the nozzle print head. If, on the other hand, mixing is to take place in a mixer arranged outside the nozzle print head, one line leading from the outlet thereof into the nozzle print head is sufficient. In typical exemplary examples, the components are at least one material component (e.g. batch paint) and at least one curing agent component which reacts in a manner known per se with the material component for the curing thereof. In an exemplary examples of the disclosure, the components remain separate at least until they enter the nozzle print head.

One advantage of the disclosure is that the fully automatic surface coating, particularly painting, in series of complete motor vehicle bodies using any desired multicomponent coating agents (including special-effect paints) is for the first time possible virtually without overspray.

As has already been mentioned, the nozzles of the print head are to direct the jets or drops of the coating composition or its components targetedly at individual points of the surface to be coated in order to avoid overspray. The impact points thereby applied can adjoin one another or overlap with one another, as will be described in greater detail.

In accordance with the prior art, it is also advantageous in the disclosure to arrange the nozzle print head on a multi-axis coating robot which moves the nozzle print head over the surface to be coated. For example, reference may be made in this connection to the coating robots having 6 or more axes, with or without a linear movement axis, which are generally known per se from the prior art.

However, the disclosure is not limited to conventional robots having 6 or more rotary axes. Instead, the nozzle applicator could be arranged, for example, on a linear unit which substantially has only linear axes for moving the nozzle print head, advantageously under program control, over the surface to be coated. Such a linear unit could be placed, for example, temporarily on the workpiece to be coated, for example on a body roof, or instead also on the conveyor thereof (e.g. the conventional skids) and would then have the advantage that accuracy problems of conventional robot and conveyor systems as regards the positioning of the nozzle print head relative to the workpiece can be avoided.

As has likewise already been discussed, the disclosure is suitable for any desired multicomponent coating compositions such as, for example, 2K or 3K paint (including base paint and clear paint), primers, adhesives or sealants or preserving agents, etc., which each have at least one batch component and a curing agent component which reacts therewith.

Mixing of the components can be carried out in different ways and at different locations of the application system.

For example, the nozzle print head can direct the at least two components separately from one another onto the surface to be coated in such a manner that they mix together on the surface. Mixing of the components thus takes place here as a result of the impact of the drops or jets. It is possible that the print head ejects the components to be mixed simultaneously. In other examples of the disclosure, however, the print head ejects the components to be mixed in succession in time, that is to say first one and then the other component (for example first the batch paint and then the curing agent, or vice versa). In both cases, the jets or drops strike at substantially the same point.

According to another possibility of the disclosure, mixing can also take place in mid-air, that is to say the nozzles of the print head are so arranged relative to one another that the components meet on the path to the surface to be coated. An appropriate distance between the nozzle print head and the surface to be coated must here be maintained, for example, by means of the coating robot. Furthermore, it is possible that the drops of the components of the coating composition are ejected at different speeds and at different times so that the drop that is ejected later meets the drop ejected first in mid-air and mixes therewith.

As has already been mentioned, drops of different sizes can be generated using, for example, electric-valve-controlled nozzles. According to the disclosure it is possible by means of different drop sizes to adjust inter alia the mixing ratio if the components are not mixed until after they have left the nozzles.

According to a further possibility of the disclosure, however, mixing can also take place at or in the nozzle print head, for example by means of a mixer which, in a manner known per se, can be in the form of a static or dynamic mixer. The mixer can be arranged in or at the nozzle print head, for example integrated in the print head in a respective inflow passage of the nozzles, where it is connected to the at least two separate supply lines of the application device.

According to another possibility for mixing the components in the print head, the individual nozzles of the nozzle print head can also each be configured for mixing the components. According to a corresponding exemplary example of the disclosure, the respective nozzles can contain at least two passages leading to a nozzle outlet, which passages can extend concentrically to one another in this example, whereby the nozzle outlet can be formed by at least one annular gap and a central opening. In this exemplary example, each nozzle of the nozzle print head is thus actually a unit having at least two nozzle elements, namely the outlet openings of this nozzle unit.

In particular in each of the mentioned possibilities for mixing without a mixer, it can be advantageous to impart a swirling motion to at least one of the components, but preferably to both or all the components, whereby they mix better.

If the components are not mixed via a mixer, it can be necessary in the case of the application of cohesive jets to ensure the mixing ratio of the two components by regulating the volume flow rate of the two components. In the case of the application of drops, the mixing ratio can be controlled via the volume of the drops, for example by means of different opening times of the nozzles.

If a mixer is to be provided, it could also be integrated according to a further possibility of the disclosure into the supply lines outside the print head, preferably as close as possible to the nozzle print head or in the vicinity of a colour changer. The mixer has corresponding inlets, at which it is connected to the at least two separate supply lines, while its outlet is connected to the nozzle(s) via a common line.

Controlled colour change valve arrangements, conventionally referred to as colour changers, for selecting a desired coloured paint from a plurality of supplied different colours are generally known per se. In the case of the disclosure too, at least one colour changer can be provided which is connected to at least one of the supply lines of the application device or of the nozzle print head, for example for a batch paint component. The colour changer can advantageously be movably arranged, in particular on the coating robot which moves the nozzle print head, for example on one of its arms or also on a linear movement axis of the robot. The closer the colour changer to the nozzle print head, the smaller the unavoidable paint and flushing medium losses in the event of a colour change. However, the colour changer can instead also be arranged stationarily, for example on an inside or outside wall of the coating booth of the coating system in question here.

The nozzle print head can be formed by a nozzle plate which, as nozzles, contains openings arranged side by side in a plate plane. The nozzles can preferably be arranged in one or more parallel rows, for example also as columns and rows of a matrix. In corresponding examples of the disclosure, the longitudinal axes of the nozzles can extend perpendicularly to the plate plane. In other examples, on the other hand, the longitudinal axes of adjacent nozzles are inclined relative to the plate plane by different or equal angles, for example opposite equal angles.

For automatically controlling their opening times, the nozzles can be connected, for example within the scope of the program control conventional for coating systems, with electric or pneumatically controlled valves arranged in or on the nozzle print head, optionally, for example, on the nozzle plate.

The control valves can have, for example, a plunger which is displaceable electrically by a coil or pneumatically and which closes or opens the nozzle depending on its position.

According to an aspect of the application device according to the disclosure which is important especially for multicomponent coating compositions is the cleaning thereof before and after coating operations. For example, the nozzle print head can be flushed after a specified time or operating period, for example hourly or after several hours or at specific times of day (end of a shift or production, weekend) etc. or when a specific number of coated workpieces has been reached or when a specific amount of ejected paint has been reached. It can likewise be expedient to flush the nozzle print head after specific events of the coating operation, for example after every stoppage of a belt or other conveyor device conveying the vehicle bodies or other workpieces to be coated through a coating booth in the conventional manner, or after a predetermined number of conveyor stoppages. Flushing can also take place under signal control after a predetermined period of time has elapsed, for example as a result of an alarm or fault warning signal after the elapse of a period of time after which the reaction of two components is so far advanced that the application system must be flushed in order to avoid damage. In the case of the coating of bodies, flushing can also take place during the so-called body gaps, that is to say when, in the breaks after the coating of one body, the robot is waiting for the next body conveyed through the coating booth. The flushing operations can be controlled automatically in dependence on time monitoring devices.

Different flushing media can be used for the cleaning, depending on the application. For example, in the case of a change of the coating operation between solvent-based (2K) paint and water-borne paint, different flushing media may be advantageous in each case, whereby a separating agent such as, for example, an alcohol can additionally also be used between the two flushing media. Furthermore, flushing media with different cleaning actions can be used (cascading), for example for reducing VOC emissions (that is to say volatile organic compounds) when the content of organic solvent increases in an aqueous flushing medium. Universal flushing media for water-borne paint and solvent-borne paint are, however, also known. VOC-free flushing medium is preferably used. For this purpose, different flushing programs, which differ in terms of their program sequence and/or their duration, can be used for different paints.

It can further be advantageous, in particular before a planned break in operation, to fill or wet the inside or outside surfaces of the nozzle print head that come into contact with one or more components of the coating composition with a fluid which at least substantially prevents deposits of the coating composition and/or the reaction of two components of the coating composition (within the scope of the disclosure, reaction generally means a chemical and/or curing reaction).

For flushing, flushing medium and pulsed air can be supplied alternately in a manner known per se. In addition or instead, flushing can also be carried out using an aerosol. If it is found to be necessary after flushing, the flushed paths can subsequently be emptied or dried with compressed air.

After flushing, it is advantageous to fill the paths in question with the coating composition or the components thereof again before the start of coating, which in coating systems is conventionally referred to as pressing on. Optionally, it can be expedient to eject at least one drop or a defined amount of the new coating agent or its components through the nozzle.

The flushing device provided for the described flushing operations can be formed by at least one flushing medium line which leads parallel to the component supply lines into the application device and can optionally be connected or connectable via a mixer or directly to all the nozzles. If a colour changer is present, a flushing medium line can be connected, for example, to an inlet of the colour changer, so that the flushing medium can be fed to the nozzle print head through the supply line, for example, for the batch paint component. A flushing medium line which leads separately into the nozzle print head is also conceivable.

In advantageous examples of the disclosure, an external flushing device can further be provided in the coating system, for example a separate flushing apparatus arranged in the vicinity of the coating robot and reachable thereby. If a storage device for storing the nozzle print head during breaks in coating is provided in the coating system, the flushing apparatus can also be integrated into the storage device.

In any case, the flushing device should preferably be in such a form that the nozzle passages and also the outside surface of the nozzle print head, that is to say optionally the nozzle plate, can be flushed. Furthermore, back flushing of the nozzle plate or nozzle passages can be advantageous, wherein the flushing medium is pressed through the nozzle passage from the outside inwards, for example in order to clean a blocked nozzle. It is thus not necessary to change the nozzle print head or the nozzle plate, as would otherwise be required, and material and working time can thus be saved. For catching all the fluids that are ejected (from the nozzles) during flushing, that is to say coating composition and flushing medium and/or aerosols, the flushing apparatus can be provided with a corresponding collecting device, from which the fluids can then be separated and disposed of.

In general, the losses of coating composition and flushing medium should be as small as possible, and VOC emissions should be avoided. In the application methods described herein, paint or coating composition losses caused by a flushing operation should be limited to in any case less than 10 l, but preferably to less than 5 l, 200 ml, 20 ml, 10 ml, 5 ml or even 2 ml, and the flushing agent requirement should be limited to less than 10 l, but preferably less than 5 l, 2 l, 200 ml, 100 ml, 50 ml, 20 ml or even 10 ml.

In order to reduce the paint loss and the consumption of flushing medium during a colour change, it can also be sufficient in the processing of multicomponent paints to flush only the regions that come into contact with the colour-giving component, for example of a 2K base paint or 2K clear paint, and with the mixture of the two components.

It should be mentioned in this connection that, especially if the components are not mixed until they leave the nozzles or after they have left the nozzles, and already mixed coating material thus does not flow in the nozzle print head, losses of flushing medium and time which are otherwise required can be avoided, especially because special mixing elements then do not have to be flushed.

If mixing does not take place until the components leave the nozzle or after they have left the nozzle, this additionally has the advantage that desired mixing ratios can be established in a particularly simple manner and without problems.

Finally, it should also be mentioned that it has been discovered that the nozzle print heads known from the prior art, which are suitable only for one-component paint, can be adapted to the requirements for two-component coating compositions. In particular, the size, that is to say hydraulic cross-sections, of the nozzles and their passages are to be dimensioned according to the particular mixing ratio. Moreover, solvent-resistant materials should be used where possible, such as, for example, seals made of FFKM (that is to say perfluorinated rubber).

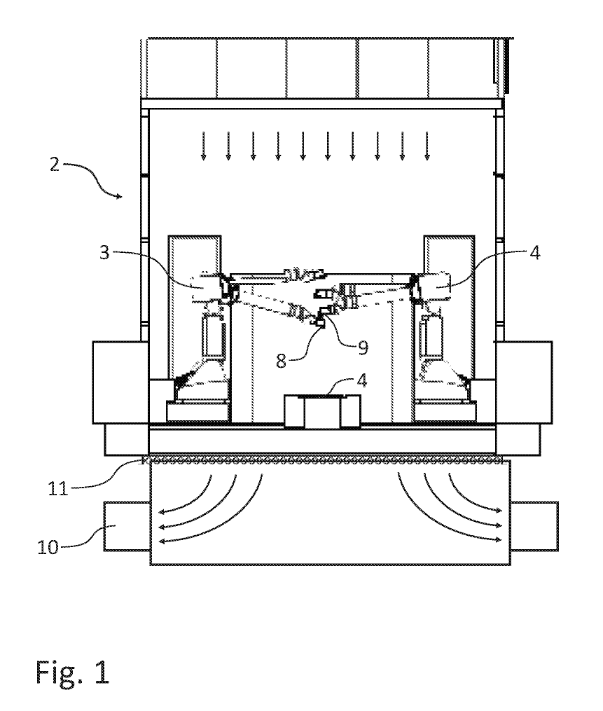

In the painting system according to the disclosure shown in FIG. 1 for the complete painting in series of motor vehicle bodies, the components to be painted are transported on a conveyor 1, at a right angle to the plane of the drawing, through a painting booth 2 in which the components are then painted by painting robots in a manner which is in part known per se. In the example shown, the painting robots 3, 4 have two pivotable robot arms and each guide an application device via a multi-axis robot hand axis. For example, the robots can be robots having six or more rotary axes and optionally a linear movement axis along the conveyor path. Painting robots having at least seven rotary axes have the advantage in the painting of bodies that the expense of a movement axis can in many cases be dispensed with.

In contrast to conventional painting systems with conventional rotary atomisers or other atomisers, the painting robots 3, 4 guide as the application device nozzle print heads 8, 9 for 2K or multicomponent paint. These nozzle print heads have a substantially greater application efficiency than atomisers of more than 95% to 99% and thus generate virtually no overspray. On the one hand, this has the advantage that it is possible to omit the washing out beneath the booth which is required in conventional painting systems with atomisers. Instead, in the painting system according to the disclosure there can be an extraction of air 10 beneath the painting booth 2 which, if required, draws the booth air downwards out of the booth through a filter cover 11 without the need for any other outlay for collecting and separating off overspray. In many cases, the extraction of air is also possible without a filter. This can also take place via passages arranged in the region of the bottom.

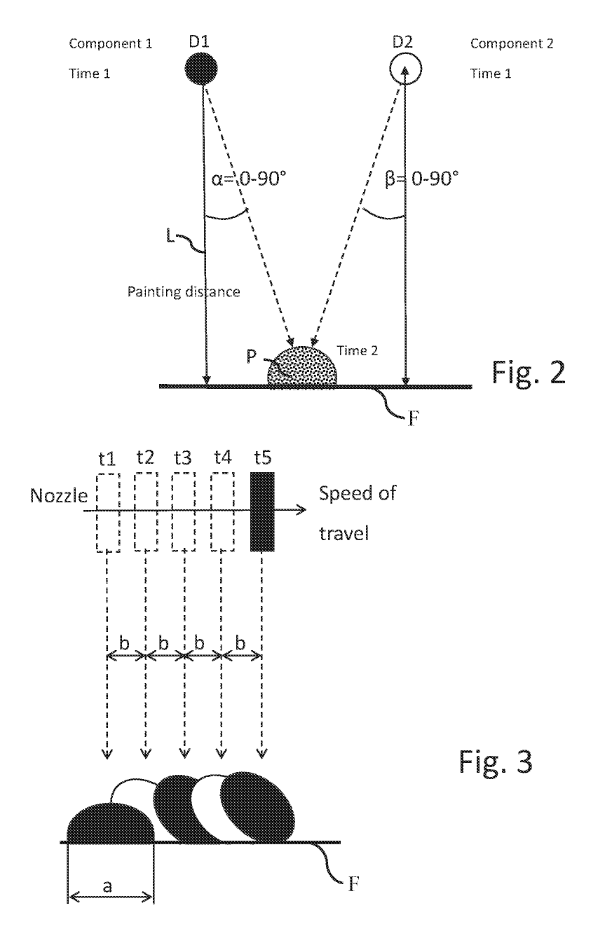

FIG. 2 explains an example of the disclosure in which two components of the coating composition are not mixed together until they strike the surface to be coated, by the impact of the drops or jets. These drops or jets are generated by two nozzles D1 and D2, shown schematically, which are arranged side by side in a common plane of the nozzle print head, one nozzle ejecting a first component (e.g. batch paint) and the other nozzle ejecting a second component (curing agent). The components can be ejected in succession in time or also simultaneously at a time 1 and, corresponding to the painting distance L of the nozzles D1 and D2 from the surface F to be coated and the speeds of travel of the components, the two components strike the surface F slightly later at a time 2, namely at least approximately at the same point P, where they are mixed with one another.

In the example shown, according to the representation, ejection directions (shown by broken lines) of the two nozzles D1 and D2 are inclined relative to the painting distance L, which is perpendicular to the surface F, and towards the respective other nozzle by, for example, opposite equal angles of travel α and β. The size of the chosen angle of travel, as well as being dependent on the painting distance L, is obviously also dependent on the distance, measured parallel to the surface F, between the nozzles D1 and D2 and can be, for example, between approximately 0 and 90°. The speeds of travel and/or the angles of travel of the two components can also be different from one another. If the nozzles D1 and D2 are opened at different times, a translation movement of the nozzles relative to the surface F during the application of the two components can also be taken into consideration.

FIG. 3 explains, schematically, the overlapping application of coating points to the surface F to be coated, there generally being applied drops of already mixed components which then in turn mix with one another on the surface F by flowing together. However, they could also be components which do not mix until they are on the surface F to be coated. While the nozzles are moved, for example, by the coating robot along the surface F with the specified speed of movement, they each generate a coating point, for example a drop, having a defined size a at predetermined successive, equally spaced times t1 to t5 etc. The respective nozzle is so controlled in terms of time that defined drop distances b along the surface F and consequently the desired overlapping of the applied drops are obtained. The degree of overlap can be between more than 0% and approximately 75% (triple overlap), that is to say approximately 10%, 20%, 30% or 50% (double overlap with b=½ a) or also b=⅓ a or ⅔ a. However, the coating points can instead be applied adjacent to one another, that is to say without an overlap (b=a).

In principle, such an application with or without an overlap is possible when the components are already mixed before or in the nozzle print head or after they have left the nozzle but before they reach the surface to be coated. An overlapping application is advantageous even if continuous jets are applied rather than individual drops.

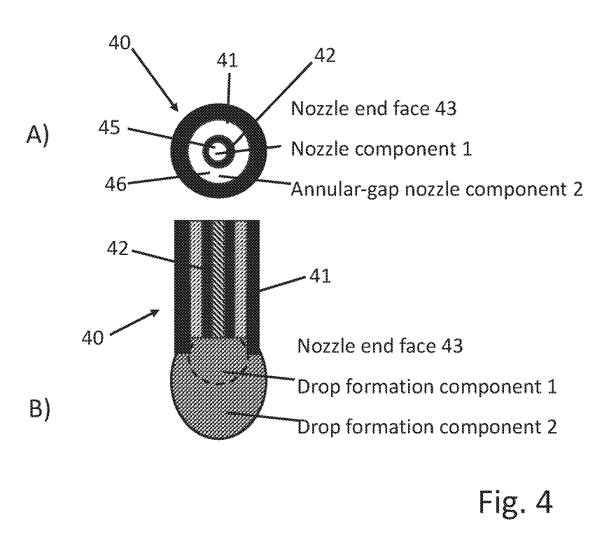

FIG. 4 shows, schematically, a nozzle unit 40 in the form of a twin nozzle for mixing two components of a coating composition (e.g. 2K paint) in or at the nozzle print head. The nozzle unit 40 consists substantially of an outer tubular body 41 in the interior, for example the cylindrical interior, of which an inner tube 42, which, for example, is likewise cylindrical, is arranged concentrically. While FIG. 4B) shows a longitudinal section through this tubular nozzle unit 40, FIG. 4A) is a plan view of the lower nozzle end face in FIG. 4B). The outer tubular body 41 can protrude outwards, according to the representation, at the nozzle end face 43 axially beyond the inner tube 42. One component of the coating composition (e.g. batch paint) is pressed through the inner tube 41 to the outlet 45, which in the example under consideration is circular, while the second component (e.g. curing agent) is pressed to the outlet 46 in the form of an annular gap between the inner tube 42 and the outer tubular body 41. Conversely, it would also be possible to guide the first-mentioned component through the annular gap and consequently the second component through the inner tube.

In the example in question here, mixing of the components takes place at the end face 43 of the twin nozzle or nozzle unit 40 shown, that is to say at the outlet thereof, where each of the drops formed there according to the representation mix with one another. It can be advantageous if the formation of the respective drops does not begin at the same time but the two nozzle elements, that is to say the inner tube 42 and the outlet 46 in the form of the annular-gap nozzle, are controlled in terms of time by valves (not shown) so that the drop is formed at the inner tubular nozzle first and only then is the drop formed at the annular-gap nozzle. The reverse sequence can also be advantageous. However, simultaneous opening of the two nozzle elements is also conceivable instead.

As has been mentioned at the beginning, the nozzle print head according to the disclosure preferably holds a plurality of such nozzle units which in particular can be arranged in one or more rows.

While the disclosure in FIG. 4 explains a twin nozzle unit using the example of drop formation, such or similar twin nozzles are also conceivable for generating component jets which can be mixed at the nozzle outlets. In both cases, the two nozzle elements can be controlled in terms of their opening times jointly and/or each individually by associated controllable valves.

As has already been mentioned, it can be advantageous to provide the components to be mixed with a swirling motion. This can be achieved, for example, by means of a spiral groove on the inside of a nozzle passage (similar in principle to a rifled gun barrel).

1.-22. (canceled)

23. Application device for the application in series of a coating composition to surfaces of workpieces, in particular of motor vehicle bodies and/or add-on parts thereof, having a nozzle print head which contains at least one nozzle or a plurality of nozzles arranged side by side which apply the coating composition to the surface to be coated as continuous jets or individual drops,
wherein the nozzle print head is in particular arranged on a multi-axis coating robot which moves the nozzle print head over the surface to be coated,
characterised in that the coating composition consists of at least two components which are to be mixed together and the application device and/or the nozzle print head has at least one or two separate supply lines for these components which are provided to jointly supply the nozzle or nozzles with the coating composition or the components thereof.

24. Application device according to claim 23, characterised in that the nozzle or nozzles of the nozzle print head targetedly direct the jets or drops of the coating composition or the components thereof at individual points of the surface to be coated in order to avoid overspray, wherein the applied impact points in particular adjoin one another or overlap with one another.

25. Application device according to claim 23, characterised in that the coating composition is
(a) a liquid multicomponent paint,
(b) a primer,
(c) an adhesive or sealant or
(d) a preserving agent,
and in each case has at least one batch component and at least one curing agent component that reacts therewith.

26. Application device according to claim 23, characterised in that
(a) the nozzle print head directs the at least two components separately from one another onto the surface to be coated in such a manner that they mix together on the surface, and/or
(b) the nozzles of the nozzle print head are so adjusted relative to one another that the components meet on the path to the surface to be coated, or
(c) the components are mixed in or at the nozzle print head, and/or
(d) the nozzle or nozzles of the nozzle print head are each configured for mixing the at least two components.

27. Application device according to claim 23, characterised in that the nozzle print head ejects the components to be mixed simultaneously or in succession in time.

28. Application device according to claim 23, characterised in that a mixer for mixing the components of the coating material
(a) is arranged in or at the nozzle print head, and/or
(b) is integrated into a respective inflow channel of the nozzle or nozzles inside the nozzle print head and is there connected on the inlet side to the at least two separate supply lines, or
(c) is arranged outside the nozzle print head in the vicinity thereof and is there connected on the inlet side to the at least two separate supply lines.

29. Application device according to claim 28, characterised in that the mixer is in the form of a static mixer or in the form of a dynamic mixer.

30. Application device according to claim 23, characterised in that there is provided at least one colour changer which
(a) is connected to at least one of the supply lines of the application device or of the nozzle print head and supplies selectable paint components of different colours to the at least one supply line in a controlled manner, and
(b) is movably arranged relative to the surface to be coated, in particular on a painting robot which moves the nozzle print head, or
(c) is fixedly arranged in a painting booth.

31. Application device according to claim 23, characterised in that the nozzle or nozzles each contain at least two passages which lead to a nozzle outlet and which preferably extend concentrically to one another, wherein the nozzle outlet is preferably formed by at least one annular gap and a central opening.

32. Application device according to claim 23, characterised in that the nozzle print head imparts a swirling motion to the ejected components by constructive shaping of the nozzle or nozzles or the supply channels thereof, for the purpose of better mixing.

33. Application device according to claim 23, characterised in that the nozzle or nozzles of the nozzle print head are controllable in respect of their respective opening and closing times, in particular by program control signals for actuating valves of the nozzles.

34. Application device according to claim 23, characterised in that the longitudinal axes of the nozzles of the nozzle print head, with respect to a plane of the nozzle print head, in particular of a nozzle plate,
(a) extend perpendicularly to the plane, or
(b) extend at an angle to the plane, in particular at different, equal or opposite equal angles of adjacent nozzles.

35. Nozzle print head of the application device according to claim 23, in particular having a nozzle plate which contains, in a plate plane, openings serving as nozzles and preferably arranged in one or more parallel rows.

36. Application device according to claim 23, characterised in that there is provided a flushing device for the nozzle print head, which
(a) is formed by at least one flushing medium line which leads into the application device and/or into the nozzle print head and to which the nozzle or nozzles are connected or can be connected, and/or
(b) is formed by an apparatus arranged externally in a coating system, in particular in the vicinity of a multi-axis robot which moves the nozzle print head.

37. Application device according to claim 36, characterised in that the flushing apparatus
(a) is configured for flushing the nozzle passages and/or
(b) for flushing an outside surface of the nozzle print head and/or a nozzle plate containing the nozzles, and/or
(c) has a collecting device for collecting coating composition and/or flushing medium ejected from the nozzles during flushing.

38. Coating system having an application device according to claim 23, in particular having one or more application robots inside a coating booth.
